(19) United States
(12) Patent Application Publication
(10) Pub. No.: US 2014/0279236 A1
(43) Pub. Date: Sep. 18, 2014

(54) Method for Enabling a Co-Branded Professional eCommerce Program

(71) Applicant: HERAEUS KULZER, LLC, South Bend, IN (US)

(72) Inventor: P. Christopher Holden, South Bend, IN (US)

(73) Assignee: HERAEUS KULZER, LLC, South Bend, IN (US)

(21) Appl. No.: 13/836,295

(22) Filed: Mar. 15, 2013

(51) Int. Cl. G06Q 30/06

(52) U.S. Cl. CPC G06Q 30/0617
USPC 705/26.43

(57) ABSTRACT

A computer-implemented method of creating and maintaining an online store, comprising the steps of establishing a master account at a system server; establishing a first account, the settings of the first account being stored in a database, wherein the first account is initiated through the master account; establishing a second account, the settings of the second account being stored in the database, wherein the second account is initiated through the first account, the second account having a link to an online store; relating the master, first, and second accounts such that purchases made at the online store are recorded and tracked at the master, first, and second accounts and control settings of the second account are determined through the master account; processing purchases made at the online store by the master account; and sharing revenue from the online store purchases by the master, first, and second account.

### FIELD OF THE INVENTION

The present invention relates to a method for selling products on the Internet, and more particularly, to a method for enabling a co-branded professional eCommerce store that is personalized for the particular professional and product.

### BACKGROUND OF THE INVENTION

Advances in computer processing power and network communications have made information and consumerism from a wide variety of sources available to users on computer networks. Computer networking allows network computer users to share information, software applications and hardware devices; and internetworking enables a set of physical networks to be connected into a single network such as the Internet. Today, computers connected to the Internet have almost instant access to information stored in relatively distant regions. Moreover, computers connected to networks other than the Internet also have access to information stored on those networks. The World Wide Web (Web), a hypermedia system used on the Internet, enables hypertext linking, whereby documents automatically reference or link other documents located on connected computer networks around the world. Thus, users connected to the Internet have almost instant access to information stored in relatively distant regions.

A page of information on the Web may include references to other Web pages and may include a broad range of multimedia data including textual, graphical, audio, and animation information. Currently, Internet users retrieve information from the Internet, through the Web, by “visiting” a web site on a computer that is connected to the Internet.

The web site is, in general terms, a server application that displays information stored on a network server computer. The web site accepts connections from client programs, such as Internet browser applications. Browser applications, such as Microsoft Internet Explorer™ or Netscape Navigator™, allow Internet users to access information displayed on the web site. Most browser applications display information on computer screens and permit a user to navigate through the Web using a mouse. Like other network applications, Web browsing uses the client-server paradigm. When given the Uniform Resource Locator (URL) of a document, the browser application becomes a client and it contacts a server application specified in the URL to request the document. After receiving the document from the server application, the browser application displays the document for the user. When the browser application interacts with the server application, the two applications follow the HyperText Transport Protocol (HTTP). HTTP allows the browser application to request a specific article, which the server application then returns. To ensure that browser applications and server applications inter-operate unambiguously, HTTP defines the exact format for requests sent from the browser application to the server application as well as the format of replies that the server application returns.

Providers of a wide range of products and/or services are continuously exploring new methods for promoting and selling them. Commercial vendors' web sites are similar to other types of web sites except that they usually incorporate functionality to enable financial transactions between users and vendors.

Currently, during an electronic commerce transaction on the Internet, a consumer enters the URL of a vendor and the browser application requests a web page associated with the URL from the appropriate server application. A persistent uniform resource locator (PURL) is a URL that is used to redirect to the location of the requested Web resource. A user of a PURL always uses the same Web address, even though the resource in question may have moved. PURL services allow the management of hyperlink integrity.

Currently, eCommerce includes a process whereby a consumer may select articles displayed on the vendor's web page and submit the selection to the vendor through the browser application. For example, a consumer on the Internet, wishing to purchase a software application, may enter the URL of a vendor into the browser application. The browser displays a corresponding web page and the consumer may order the software application on the web page through the browser application. Upon receiving the consumer's selection, the vendor requests payment for the selected articles before delivering them to the consumer. The consumer may pay the vendor through credit cards or the vendor may require cash upon delivery of the selected articles. Thus, in order to sell products on-line, vendors' web sites must incorporate functionality to enable financial transactions between users and vendors. Implementing financial functionality into a web site requires technical expertise and may prevent some merchants from establishing an on-line store.

Generally, the websites are associated with, managed by, and marketed by the provider of the product. In this highly competitive space, it is difficult to market highly specialized products to relevant customers and still insure brand loyalty. Moreover, those who are best able to effectively insure brand loyalty do not also have the expertise and capability to manage the functionality of the eCommerce sites.

### SUMMARY OF THE INVENTION

Accordingly, the present invention is directed to a method and system that substantially obviates one or more of the problems due to limitations and disadvantages of the related art. The present invention provides professionals a personalized online store to promote their practice and sell products online to customers. The present invention allows a third party professional to invite its customers to a website, which is created and managed by the inventive system, and to purchase highly specialized products. The third party shares the revenue resulting from the purchases of the products with the system.

Additional features and advantages of the invention will be set forth in the description that follows, and in part will be apparent from the description, or may be learned by practice of the invention. The objectives and advantages of the invention will be realized and attained by the method that is particularly pointed out in the written description and claims hereof as well as the appended drawings.

To achieve these and other advantages, and in accordance with the purpose of the invention, as embodied and broadly described, the present invention provides a computer-implemented method of creating and maintaining an online store, comprising a non-transitory computer readable medium including a program and a computer executable program code, the method comprising the steps of establishing a master account at a system server; establishing a first account, the settings of the first account being stored in a database, wherein the first account is initiated through the master account; establishing a second account, the settings of the second account being stored in the database, wherein the second account is initiated through the first account, the second account having a link to an online store; relating the master, first, and second accounts such that purchases made at the online store are recorded and tracked at the master, first, and second accounts and control settings of the second account are determined through the master account; processing purchases made at the online store by the master account; and sharing revenue from the online store purchases by the master, first, and second account.

In another embodiment, the present invention also provides a computer-readable storage medium, storing one or more programs configured for execution, the one or more programs for monitoring, transmitting, and recording usage of a computer or mobile device connected to a network, the one or more programs comprising instructions to establish a master account at a system server; establish a first account, the settings of the first account being stored in a database, wherein the first account is initiated through the master account; establish a second account, the settings of the second account being stored in the database, wherein the second account is initiated through the first account, the second account having a link to an online store; relate the master, first, and second accounts such that purchases made at the online store are recorded and tracked at the master, first, and second accounts and control settings of the second account are determined through the master account; process purchases made at the online store by the master account; and share revenue from the online store purchases by the master, first, and second account.

In yet another embodiment, a computer-implemented method of creating and maintaining an online store, comprising a non-transitory computer readable medium including a program and a computer executable program code, the method comprising the steps of establishing a master account at a system server; establishing a first account, the settings of the first account being stored in a database, wherein the first account is initiated through the master account, the first account having a link to an online store; relating the master and first accounts such that purchases made at the online store are recorded and tracked at the master and first accounts and control settings of the first account are determined through the master account; and processing purchases made at the online store by the master account; sharing revenue from the online store purchases by the master and first account.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a co-branding system according to an exemplary embodiment of the present invention.

FIG. 2 is a flow chart illustrating a method for implementing a co-brand site for a dentist according to an exemplary embodiment of the present invention.

FIG. 3 is a flow chart illustrating a method for using a dentist co-brand site by a customer according to an exemplary embodiment of the present invention.

FIG. 4 illustrates the Sales Rep website according to an embodiment of the present invention.

FIG. 5 illustrates the Dentist website according to an embodiment of the present invention.

FIG. 6 illustrates a website viewed by the customer according to an embodiment of the present invention.

FIG. 7 illustrates a login page for the sales representative according to an embodiment of the present invention.

FIG. 8 illustrates a page for creating a new Dentist website according to an embodiment of the present invention.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive system and method for setting up an on-line store over the Internet.

In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented by any type of user (i.e., not limited to the examples herein) and on any type of standalone system or client-server compatible system containing any type of client, network, server, and database elements.

FIG. 1 illustrates a co-branding system according to an exemplary embodiment of the present invention. As shown in FIG. 1, the co-branding system 100 includes a system server 101, Sales Rep Computer 102, Practice Computer 103, and customer computer 104. The co-branding server 101 may include a persistent software system and service that allow one or more Sales Reps responsible for one or more Practices to establish a controlled product management and payment system for use over the Internet. The preferences are stored on a database, and include Sales Rep and Practice preferences and controls for the money management. Each of the Sales Rep Computer 102, Practice Computer 103, and customer computer 104 may be a desktop computer, laptop computer, tablet or portable computer, smartphone, mobile phone, or other portable computing device.

For example, the system may set up sites that are seemingly “owned” by a particular dentist to sell highly specialized teeth whitening products that are sold only by dentists. These highly specialized products compete with over-the-counter products, which may or may not be as effective. Moreover, dentists cannot control their patients' use of over-the-counter products, which control may be needed for optimum health. Juxtaposed with these concerns are the very real concerns a dentist has in trying to market, supply, sell, and deal with all the financial aspects of selling the highly specialized products. These professionals are not trained in the areas of commerce discussed above, and thus, sales are not effectively made and sustained by consumers. Accordingly, the present invention enables the system to manage the marketing of products, supplying of products, and the financial processing of products sold; while at the same time allowing the dentist to control the patients' needs and to better assist patients with their choices of products best suited to their needs. Moreover, the system allows that all parties involved in the marketing and sale of the products share in the revenue generated there from.

The following description uses as an example a product sales representative as the person assisting in setting up a co-brand site for a dentist, as the Practice. These are only examples, and the invention is not limited to those two classes of people.

FIG. 2 is a flow chart illustrating a method for implementing a co-brand site for a dentist according to an exemplary embodiment of the present invention. At step 201, a system administrator signs in by entering a user name and password, or other methods known to those skilled in the art. Once signed in, the administrator is able to view and create, inter alia, Sales Reps accounts at step 202. Any number of Sales Reps accounts may be created, one for each person (sales representative) who will directly contact professionals (dentists). Once created, the Sales Rep accounts are stored in a system database at step 203, and an email, or other mode of communication known to those skilled in the art, is sent to the sales representative for whom the Sales Rep account was created and exists at step 204.

The email to the sales representatives includes a link for the sales representative to access, and allows the sales representative to log into the system site at step 205 through the Sales Rep account. This login may include inputting a user name and password, or other information known to those skilled in the art. FIG. 7. Once into the Sales Rep account, the sales representative can access information about all dentist accounts within that Sales Rep account, and also can access a web page to create more dentist accounts. Other available information on the site will be known to those skilled in the art. The sales representative may create Dentist Accounts at step 206 by clicking on a “Create Dentist” link (See FIG. 8, 801), which when clicked, takes the sales representative to a screen for creating a new account for a dentist. This screen may include a PURL textbox into which the sales representative puts the dentist's name, the name of the practice, or generally whatever the dentist wishes to use to identify the site to the particular practice within the options. (step 207)(FIG. 8, 802). The availability of the name may be checked, and if available, a Dentist Account is created in the administrative system database at step 208. Once created, the dentist receives an Account Created email, or other form of communication known to those skilled in the art, and the dentist account is displayed in a list of dentist accounts on the Sales Rep account site.

In an alternative embodiment, the dentist may implement the co-brand site, without the use of a sales representative. In this alternative, a dentist may go to the system home page, which may include a link that will enable the dentist to log into the system site. Alternatively, the system may send an email to a prospective dentist that will include a link to a prospective account. Other modes of communication will be known to those skilled in the art. Once the dentist is at the system site, the dentist may create an account by clicking an “Create” link, which when clicked, takes the dentist to a screen for creating a new account. This screen may include a PURL textbox into which the dentist puts the dentist's name, a practice name, or any name the dentist wishes to use to identify the particular practice. The availability of the name may be checked, and if available, a Dentist Account is created in the administrative system database. Once created, the dentist receives an Account Created email, or other form of communication known to those skilled in the art

The final sign-up is handed over to the dentist via the Account Created email. When the dentist clicks on a link within that email, the dentist is sent to a set up site within the system administrative website at step 209. There, the dentist may accept the agreement, which may include entering an email address and password and agreeing to the license and services agreement, and other information known to those skilled in the art. Also, the site may present the dentist with a W-9 tax form and ACH direct deposit form to complete and send to the system at step 210. The dentist also may create a personalized paragraph about the practice that will appear on the site used by customers. These will be discussed in detail below. Once all of the steps are performed, the dentist's site is live and may be accessed by customers via the PURL set up earlier by the sales representative.

FIG. 3 is a flow chart illustrating a method for using a dentist co-brand site by a customer according to an exemplary embodiment of the present invention. At step 301 the customer enters the PURL, and is directed to the dentist's branded website. The customer may click on a link that says “Shop” and is then redirected to the system site, which contains products for sale (step 302). Once the customer chooses a product, such as a teeth whitening product, the customer may “checkout” at step 303. At checkout, the customer may input billing information at step 304. The customer also may register at the site, by inputting an email address, username, password, shipping information, credit card information, and other information known to those skilled in the art. Once registered, a customer need only input the username and password for the system to access stored shipping and billing information. Account information such as a user name, password, or payment information, and notification sending information may be stored in a secure database by the system. SSL security feature may be the secure socket layer standard that provides the encryption layer for secure data transmission. At checkout, a customer also may be asked to give the name of the dentist staff who referred the website, and may be asked to receive email notifications of coupons, promotional information, etc. This will encourage return visits by the customer.

The system manages all sales and shipping of products sold. Once an order is received by the system, inventory is checked, the product is shipped to the customer per the address input at checkout. All billing is handled by the system as well. This may include calculating and charging shipping costs, sales taxes, and other features known to those skilled in the art. The dentist does not have to deal with these issues with the sale of the products.

Because the sales are made through a specific dentist website, the system is able to determine which sales representative and dentists were involved in the sale. A dental products distributor also may be involved in the overall transaction. For example, a dentist may designate an authorized dealer of the particular products of choice at the dentist's site at sign up. This dealer is then is tied to the account. As discussed below, that dealer may receive an income from a portion of sales as well. The designated dealer may be changed or omitted by the dentist, depending on variables known to those skilled in the art. Accordingly, the revenue may be shared by all parties. For example, the revenue may be shared as a certain percentage of net product sales is paid to the dentist, a certain percentage is paid to the product dealer (which may be further divided to include the particular sales representative associated with that dentist), and a certain percentage going to the system representative. These payments may be made through the direct deposit account set up by the sales representatives and dentists when the sites were set up. Of course, other forms of payment also are available. A dentist may receive a check, or any form of payment known to those skilled in the art. The sales representative also may be paid through a direct deposit, a check, or other forms of payment known to those skilled in the art.

FIG. 4 illustrates the Sales Rep website, which can be accessed at the Sales Rep Computer (FIG. 1), through the system's Admin website, as discussed above. When the sales representative enters the username (may be an email address or other name) and password, the sales representative is taken to the personalized website 400. This site may contain a list of dentist accounts that are active 401, may contain a list of dentists that are inactive 402, and may contain a link to sign up a new dentist 403. If the sales representative clicks on an active dentist 401, the representative may access all the current information about that dentist. This may include high-level only order information for the dentist account, which may include the dentist's earnings, total number of orders, the breakdown of items ordered, and other information known to those skilled in the art. If the sales representative clicks on the sign up link 403 (“Create Dentist Account”), the representative may access a sign-up page, as discussed above. This may include a link to the direct deposit forms and tax forms that a new dentist must download and complete. The Sales Rep website also may include a link to a Resources page 404. This link may take the sales representative to a display of resources available to help support the online sale of products, the signing up of dentists, etc. The Sales Rep website may include a link to a W-9 tax form and ACH direct deposit form 405, which are used during the creation of the Dentist site, as discussed above.

FIG. 5 illustrates the Dentist website, which can be accessed at the Dentist Computer (FIG. 1) through the system's PURL that the sales representative set up for the dentist, as discussed above. When the user name and password is input, the dentist is taken to a website that may contain information regarding the overall sales orders made through the dentist's site 501, orders broken down by quarter 502, order details, and a listing of staff members who were listed by customers as having referred them to the site. The site also may contain a link to a Resources page 504, which may aid the dentist in describing the product to patients, etc.

FIG. 6 illustrates a website 600 viewed by the customer. As explained above, the customer reaches the site by putting in the dentist's PURL at the Customer computer, which has been given to the customer by the dentist (or a staff member). The site is customized for the particular dentist. It may have the dentist's or practice's name on the banner 601, and may have further information about the practice 602, and a custom paragraph further describing the practice. The site may have a link to particular products that may be purchased 603.

The foregoing description has been directed to specific embodiments of this invention. It will be apparent; however, that other variations and modifications may be made to the described embodiments, with the attainment of some or all of their advantages.

What is claimed:

1. A computer-implemented method of creating and maintaining an online store, comprising a non-transitory computer readable medium including a program and a computer executable program code, the method comprising the steps of:
establishing a master account at a system server;
establishing a first account, the settings of the first account being stored in a database, wherein the first account is initiated through the master account;
establishing a second account, the settings of the second account being stored in the database, wherein the second account is initiated through the first account, the second account having a link to an online store;
relating the master, first, and second accounts such that purchases made at the online store are recorded and tracked at the master, first, and second accounts and control settings of the second account are determined through the master account;
processing purchases made at the online store by the master account; and
sharing revenue from the online store purchases by the master, first, and second account.

2. The computer-implemented method according to claim 1, wherein the first account comprises information regarding the related second account and a link to a system site wherein second accounts are established.

3. The computer-implemented method according to claim 1, wherein the step of establishing the first account comprises creating and storing a first login user name and password in the database, and sending by the master account an email to a user of the first account.

4. The computer-implemented method according to claim 3, wherein the email instructs a user to login and create the second account.

5. The computer-implemented method of claim 1, wherein the step of establishing the second account comprises linking from the first account to the site for establishing a second account and creating and storing a second login user name and password in the database and sending by the master account an email to a user of the second account.

6. The computer-implemented method of claim 5, wherein the step of establishing the second account further comprises creating a PURL for the second account.

7. The computer-implement method of claim 5, wherein the email instructs a user of the second account to create and send to the master account direct deposit and tax forms.

8. The computer-implemented method of claim 5, further comprising populating the second account with a link to an online store.

9. The computer-implemented method of claim 1, wherein the step of processing purchases comprises assigning tax charges to the purchase, calculating shipping costs, collecting payment from a consumer making the purchase, tracking and moving the purchase to the consumer.

10. The computer-implemented method of claim 1, wherein the step of processing purchases comprises creating an account for a consumer making the purchase, obtaining consumer billing information, and obtaining consumer shipping information.

11. The computer-implemented method of claim 1, wherein the step of sharing revenue comprises determining by the master account the first and second accounts involved in a purchase and sharing a percentage of revenue from the purchase to the involved first and second accounts.

12. The computer-implemented method of claim 11, wherein sending the percentage of revenue comprises directly depositing the shared revenue at the master, first and second accounts.

13. A computer-readable storage medium, storing one or more programs configured for execution, the one or more programs for monitoring, transmitting, and recording usage of a computer or mobile device connected to a network, the one or more programs comprising instructions to:
establish a master account at a system server;
establish a first account, the settings of the first account being stored in a database, wherein the first account is initiated through the master account;
establish a second account, the settings of the second account being stored in the database, wherein the second account is initiated through the first account, the second account having a link to an online store;
relate the master, first, and second accounts such that purchases made at the online store are recorded and tracked at the master, first, and second accounts and control settings of the second account are determined through the master account;
process purchases made at the online store by the master account; and
share revenue from the online store purchases by the master, first, and second account.

14. A computer-implemented method of creating and maintaining an online store, comprising a non-transitory computer readable medium including a program and a computer executable program code, the method comprising the steps of:
establishing a master account at a system server;
establishing a first account, the settings of the first account being stored in a database, wherein the first account is initiated through the master account, the first account having a link to an online store;
relating the master and first accounts such that purchases made at the online store are recorded and tracked at the master and first accounts and control settings of the first account are determined through the master account;
processing purchases made at the online store by the master account; and
sharing revenue from the online store purchases by the master and first account.
